(19) United States
(12) Patent Application Publication
(10) Pub. No.: US 2006/0036470 A1
(43) Pub. Date: Feb. 16, 2006

(54) Systems and methods for providing a pharmacy management analysis report

(76) Inventor: Lee Oaks, Madill, OK (US)

Correspondence Address: DUNLAP, CODDING & ROGERS P.C., PO BOX 16370, OKLAHOMA CITY, OK, 73113, US

(21) Appl. No.: 11/044,493

(22) Filed: Jan. 27, 2005

Related U.S. Application Data
(60) Provisional application No. 60/539,767, filed on Jan. 28, 2004.

(51) Int. Cl. G06Q 50/00

(52) U.S. Cl. 705/2; 705/10

(57) ABSTRACT

A pharmacy management analysis report as generated by the steps of introducing servicing information for a plurality of prescriptions filled by an individual pharmacy into a program, and automatically summarizing in a reader friendly format the activities of the pharmacy along with comments as to overall performance of the pharmacy. Such activities include those relating to prescription pricing, third party reimbursements, generic and brand utilization, profit generated, and prescription replacement cost. The analysis report preferably also includes a Detail report section which focuses on pricing, reimbursements and margins of profit for each individual pay plan program or entity.

### CROSS-REFERENCE TO RELATED APPLICATIONS

The present application claims priority to the provisional patent application entitled “PRESCRIPTION ANALYSIS REPORT FOR INDEPENDENT PHARMACY'S”, and identified by the U.S. Ser. No. 60/5339,767, which was filed on Jan. 28, 2004; the entire content of which is hereby expressly incorporated herein by reference.

### SUMMARY OF THE INVENTION

The present invention relates to a method and system for generating a pharmacy management Analysis Report. The Analysis Report provides a pharmacy with a summary of pharmacy's servicing activities, and in particular but not by way of limitation, to those which include prescription pricing, third party reimbursement, generic utilization and brand name utilization.

The method and system includes a computer, a program, at least one input device and at least one output device. The method and system also includes servicing information which is inputted via the input device into the computer such that the servicing information is accessible to and sortable by the program. The servicing information includes at least data that relates to a description of a prescription and a classification of the prescription.

### BRIEF DESCRIPTION OF THE DRAWINGS

FIG. 1 is a block diagram of a system ro providing an Analysis Report.

FIG. 2 is a logic flow diagram illustrating the logic loop of the system for producing an Analysis Report in accordance with the present invention.

FIG. 3 is a logic flow diagram illustrating the logic of a step of the system shown in FIG. 2.

FIGS. 4A-4B cooperate to show an exemplary Analysis Report generated by the system of FIG. 1.

More particularly, FIG. 4A shows one embodiment of a Summary portion of the exemplary Analysis Report.

FIG. 4B shows one embodiment of a Detailed Report portion of the exemplary Analysis Report.

FIG. 4C shows one embodiment of a Statics Report portion of the exemplary Analysis Report.

### DETAILED DESCRIPTION OF THE PREFERRED EMBODIMENTS

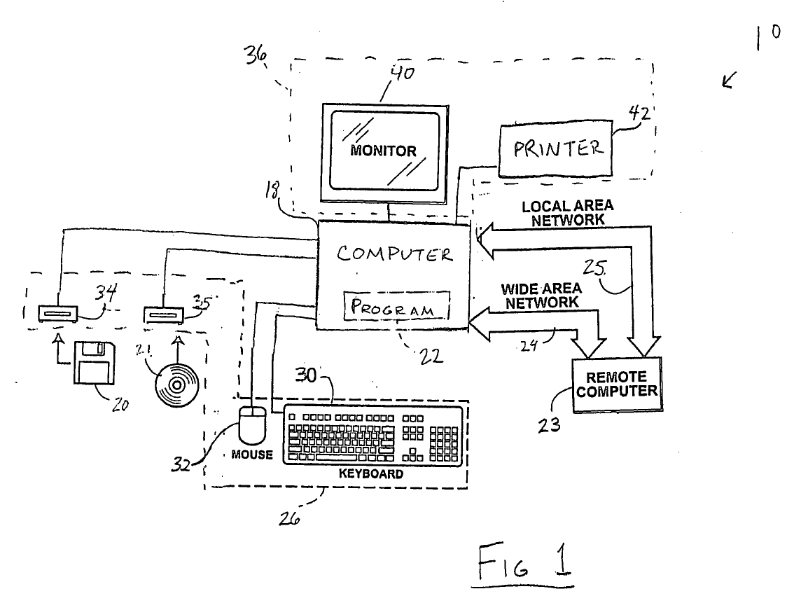

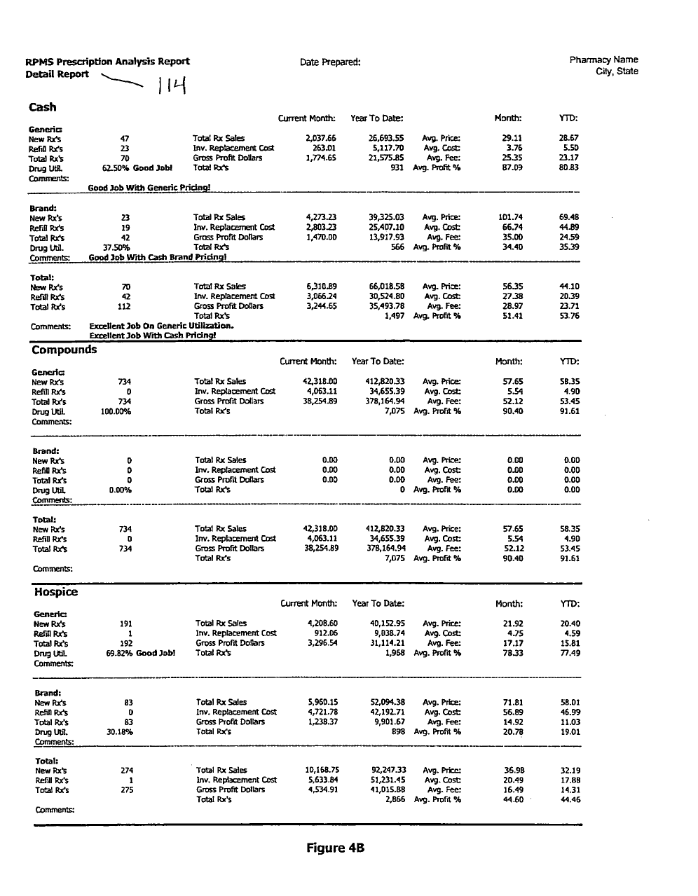

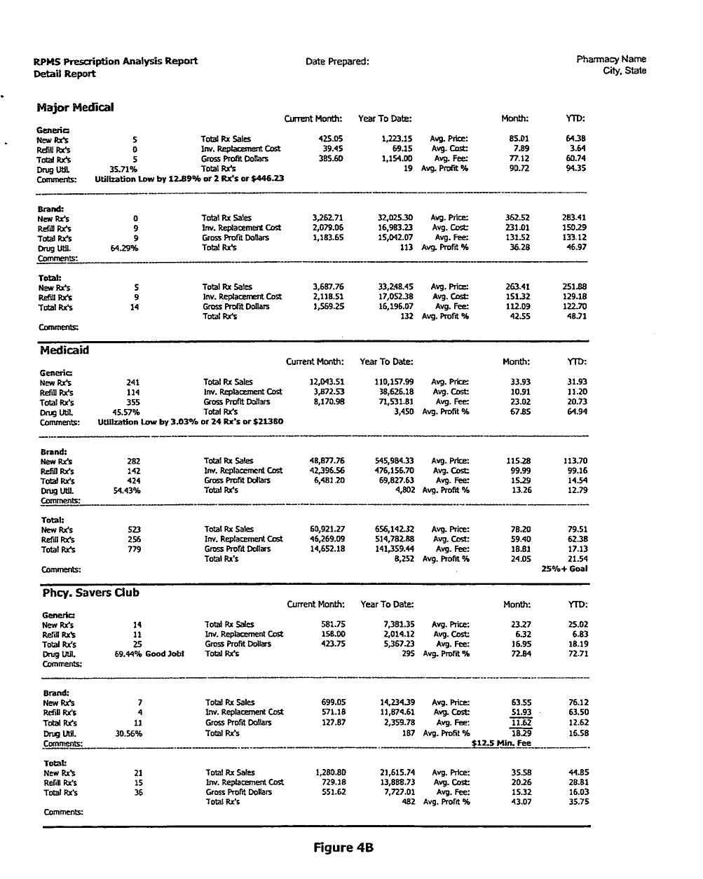

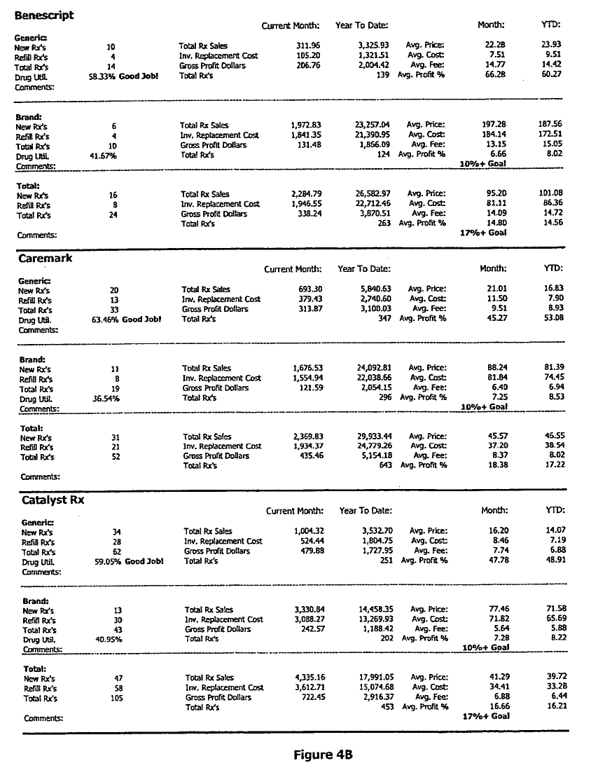

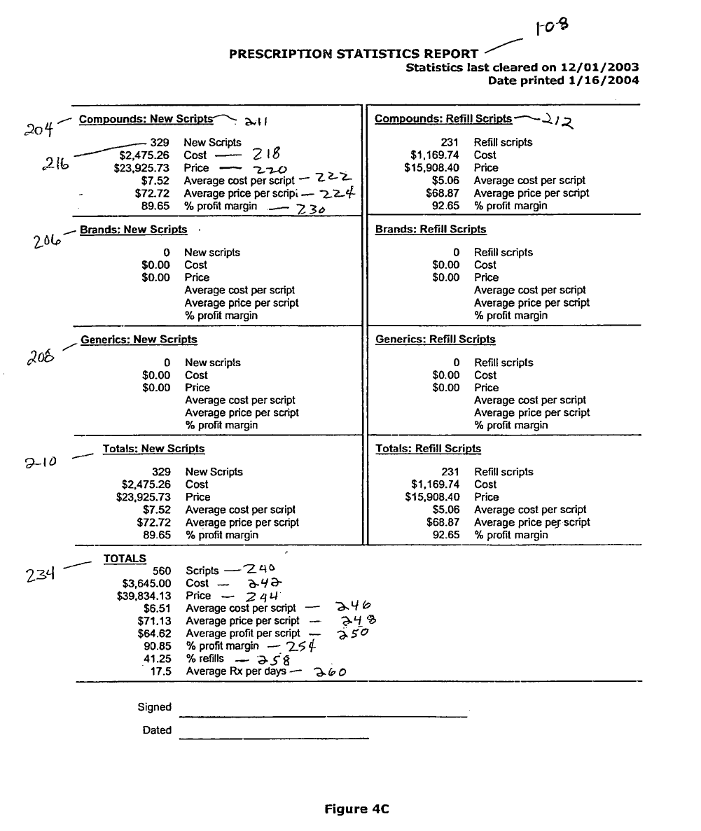

Referring now to the drawings, and more particularly to FIG. 1, shown therein is a system 10, for producing an Analysis Report 14 (see FIG. 4) for a pharmacy. The system 10 for producing the Analysis Report 14 includes a computer 18 and a program 22 which is accessible by the computer 18. However, the program 22 or portions there of can also be stored externally on a computer readable medium, such as for example on a floppy disk 20, CD 21, DVD, flash memory, zip drive, external hard drive or the like. The program 22 can also be stored remotely from the computer 18 and accessed by the computer 18 via the internet or other network connection. For example, the program 22 can be stored on a remote computer 23 (e.g. a website host computer or a LAN computer) connected to the computer 18 via a Wide Area Network (WAN) connection 24 and/or a Local Area Network (LAN) connection 25. The system 10 further includes at least one input device 26 (such as a keyboard 30, a mouse 32, a magnetic disk drive 34, and optical disk drive 35) and at least one output device 36 such as at least one monitor 40 and/or at least one printer 42.

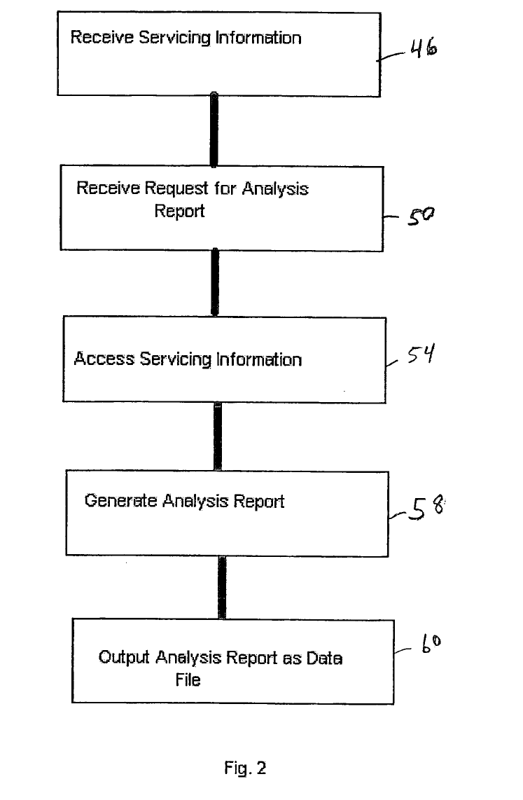

Referring now to FIG. 2, shown therein is a logic flow diagram illustrating the general logic loop for a method of producing the Analysis Report 14 for a pharmacy utilizing the system 10 of the present invention. To prepare the Analysis Report 14 for the pharmacy, a user of the system 10 (e.g., a pharmacist or other pharmacy employee) provides or inputs servicing information 46 to the computer 18 via the at least one input device 26 such that the servicing information 46 is accessible and sortable by the program 22.

In general, the servicing information 46 is data that is associated with or identifies at least one prescription filled or serviced by the pharmacy. The servicing information is inputted into a plurality of categories 47 defined by the program 22. The plurality of categories can include at least one category for a filling date , a description of the prescription (e.g., the name of the product or drug, quantity, etc), a classification of the prescription distributed to a patient (e.g., name brand or generic), a status of the prescription being filled (e.g., new or refill), a cost price associated with the prescription (i.e., the cost to the pharmacy), a selling price associated with the prescription (i.e., the price the prescription is sold to a patient), and a description of an entity paying on the prescription (e.g., an individual's name, a third party company or program's name, etc.). The servicing information 46 can also include information concerning a co-pay amounts and/or a discount amounts, if applicable, or a description of the payment (e.g., cash, charge, reimbursement, etc.).

The servicing information 46 can also include a fee amount which is the difference between the selling price of the prescription and the cost of the prescription, and the percentage profit margin for each prescription. However, it should be understood that product margin information is preferably computed by the program 22 based on other servicing information 46 provided. The servicing information 46 can also include information such as a patient's name, a doctor's name, a nurse's name or other record keeping type information.

Typically, the pharmacy will fill more than one prescription, and so the user may input servicing information 46 for each prescription. Preferably, the servicing information 46 for each prescription is inputted into the computer 18 via the at least one input device 26 near in time to when the particular prescription is ordered or filled, and the servicing information 46 is stored by the computer 18 or the remote computer 23 or any other accessible electronic storage device until a request to generate an Analysis Report 14 is inputted into the computer 18 and received by the program 22. However, the servicing information 46 for each prescription can be collectively provided to the computer 18, by the user inputting the servicing information 46 in one session, or by the computer 18 accessing the servicing information 46 from a computer readable medium (e.g., floppy disk 20, CD, DVD, external hard drive or flash memory) or from a remote computer or database. Also, it should be understood that the servicing information 46 can include information, such as batch totals, averages, profit margins, etc. However, batch totals, averages and profit margins information are preferably computed by the program 22 based on data inputted.

Once the servicing information 46 has been inputted into the computer 18 such that the servicing information 46 is accessible and sortable by the program 22, a user can request the program 22 via the input device 26 to generate the Analysis Report 14, as shown in step 50. The user can also specify which of the plurality of categories by which the program 22 should sort the servicing information 46. For example, the user can specify that the program 22 only consider the servicing information 46 for the description of the prescription and the filling date of the prescription if the prescription was filled with a certain time period, such as for example within a specific week, month, year or multiples and combinations thereof. As such, the program 22 can be used to determine and indicate monthly figures as well as year-to-date, quarterly, or life-time figures and trends.

After the request from the user is inputted into the computer 18 and received by the program 22, the program 22 accesses the servicing information 46, as shown in step 54. Based on the data in the servicing information 46 and the categories selected by the user, the program 22 generates the Analysis Report 14, as shown in step 58. As shown in step 60, the Analysis Report 14 is output as a data file so that the Analysis Report 14 can be saved and/or printed and/or viewed by the user via the computer 18 and the at least one output device 36. For example, the Analysis Report 22 can be displayed on the monitor 40 and/or printed out by the printer 42.

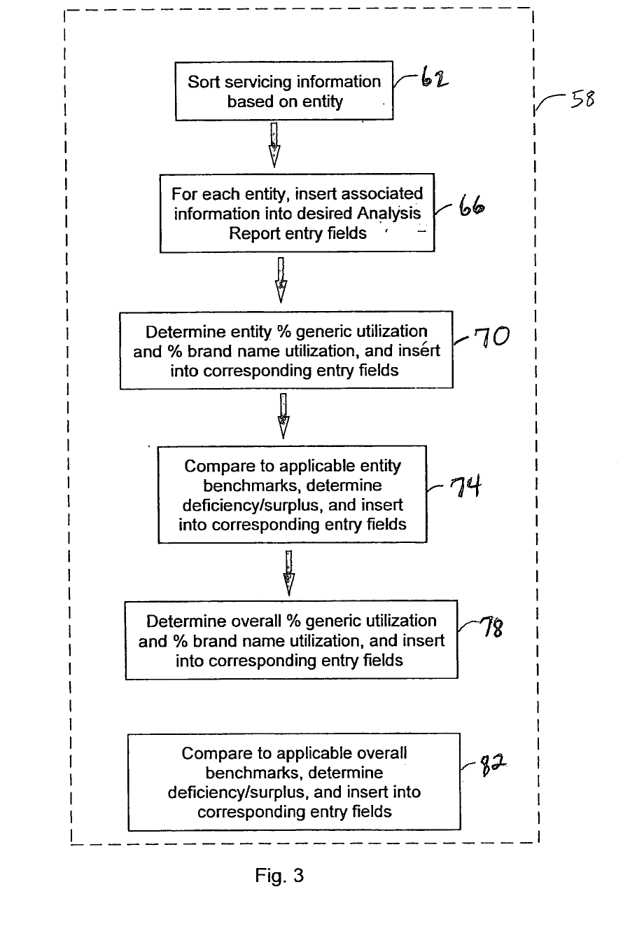

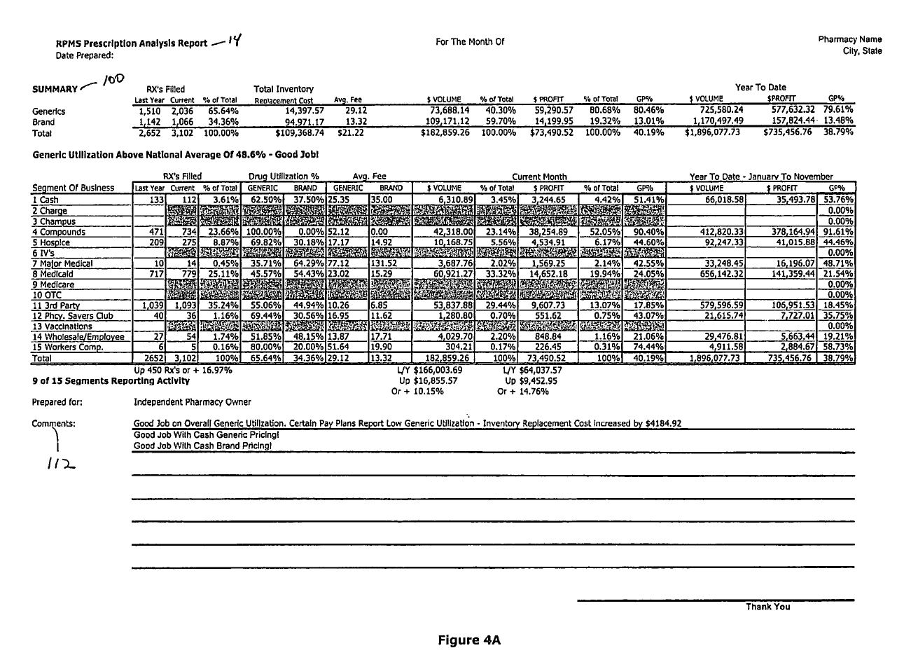

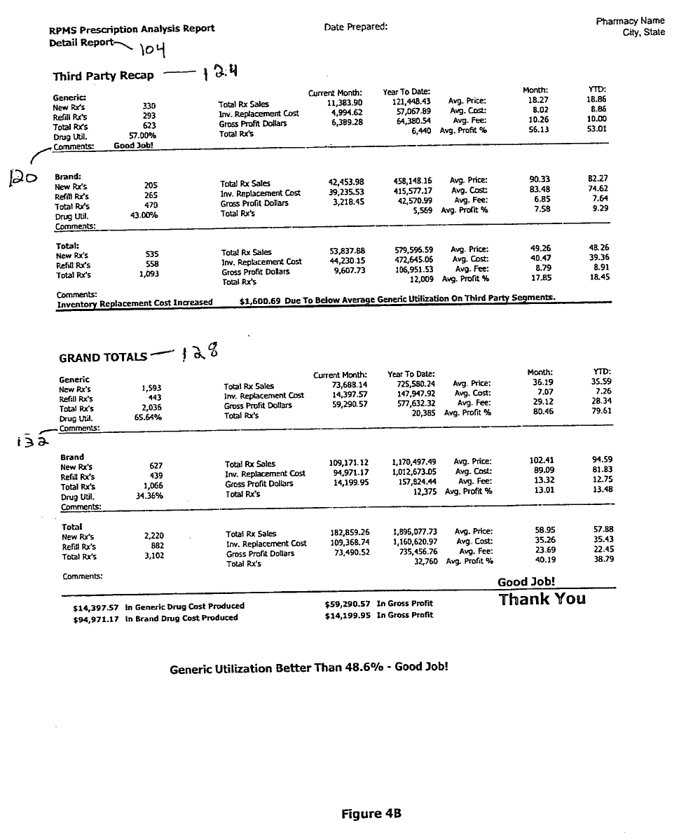

Referring now to FIG. 3, shown therein is a logic flow diagram illustrating one embodiment of a main logic loop performed by the program 22 in the step 58 shown in FIG. 2 to generate the Analysis Report 14. In general, the program 22 sorts and evaluates the servicing information 46, to provide analysis information which can be used to more fully evaluate pharmacy prescription activities.

In the embodiment shown in FIG. 3, the program 22 sorts the servicing information 46 based on the description of the entity paying on the prescription, as shown in step 62. The program 22 provides in the Analysis Report 14 a break down of associated information, including cross-linked information, as shown in step 66. For example, the Analysis Report 14 can list for each entity the number of new and refill prescriptions for both the generic classification and the brand name classification of the prescriptions associated with entity, as distributed to the patient category 56 shown in FIG. 4B.

In one embodiment, the program 22 computes for each entity the percentage of prescriptions that were filled utilizing generic products or drugs, and the percentage of prescriptions that were filled utilizing name brand products or drugs, as shown in step 70. The program 22 then includes both utilization percentages in the Analysis Report 14, as shown in FIG. 4B. Further, at least one benchmark can be incorporated into the program 22. In one embodiment, the program 22 compares the determined generic utilization percentage and/or the determined brand name utilization percentage against a benchmark that was predetermined or user defined for that prescription classification, as shown in step 74. The benchmark can be entity specific, or can be a universal benchmark. For example, the benchmark for generic utilization can be set to 48.6 percent. That is, the benchmark for the number of prescriptions filled and sold using generic products would desirably be at least 48.6 percent of all prescriptions sold by the pharmacy.

The program 22 can then indicate in the Analysis Report 14 whether the benchmark has been met (for example by displaying a “Utilization Low” or “Good Job” indicator), as best shown in FIG. 4B. Thus, when the Prescription Analysis Report is computed and printed one will be able to determine if the pharmacy is either above or below the prescribed benchmark for the generic products sold, for example.

Also, the program 22 can compute the amount of deficiency or surplus of the benchmark, as also shown in step 74, and indicate the same in the Analysis Report, as shown for example in FIG. 4. The deficiency or surplus determination can be in terms of a difference and/or can be put in other terms, such as inventory replacement cost. For example, if the average brand cost is $55.00 and the average generic cost is $5.00, the report indicates that it will cost the pharmacy $50.00 more to replace a brand prescription than a generic prescription. Thus, if the report indicates that the pharmacy was ten prescriptions short in meeting generic utilization, the inventory replacement cost for the pharmacy for the additional ten prescriptions will increase by $500.00.

Although the benchmark have be described generally above with reference to generic utilization, it should be understood that a benchmark can be incorporated in the program 22 for other characteristics. Also, it should be noted that each entity or pay plan may have benchmarks associated with it, which may vary from the other entities. The program 22 can utilize a benchmark in preparing the Analysis Report 14 accordingly. For example, the entity “Caremark” may utilize four benchmarks, namely, generic prescription fee, brand name prescription fee, brand name profit and overall profit; whereas the entity “Pharmacy Savers Club” may utilize only three benchmarks, namely minimum fee for generic prescriptions, minimum fee for brand name prescriptions, and overall profit margin. Thus, when multiple benchmarks are predefined and/or entered into the program 22, the program 22 employs only those associated with the entity being evaluated. Further, the program 22 can advise as to what benchmarks are used.

As shown in step 78 of FIG. 3, in addition to computing and indicating the percentages and benchmark for each entity as describe above, the program 22 also determines the percentage of generic prescriptions filled and the percentage of name brand prescriptions filled for all the prescriptions filled by the pharmacy, in a similar manner as described for each entity in step 70. The program 22 can also, as shown in step 82, determine whether benchmarks have been met, in a similar manner as described for step 74. The program 22 then lists these overall percentages and results of the benchmark determinations in the Analysis Report 14, as shown in FIG. 4A.

Preferably, the program 22 also determines and lists in the Analysis Report 14 other information that can be useful to evaluate the pharmacy's activities. Such information can be provided in predetermined entry fields in the Analysis Report 14, or the program 22 can allow the user making the request to specify the types of information to be included in the Analysis Report 14.

The following description, and the embodiment of the Analysis Report 14 depicted in FIGS. 4A-4C, include various examples of the categories that can be included. However, it should be understood that some of the categories can be omitted and/or other categories can be added in accordance with the present invention.

The program 22 can determine and list in the Analysis Report 14 is the total number of prescriptions filled, the number of prescriptions filled with generic products, and the number of prescriptions filled with brand name products for all the prescriptions filled by the pharmacy. Such values can also be further separated into prescriptions falling within certain a category, such as for example those associated with a certain description, classification, entity name, or payment method type. Another entry that can be determined and listed is the total cost of all the prescriptions, the cost of the generic prescriptions, and the cost of the brand name prescriptions for all the prescriptions and/or those falling within a certain category. Yet another entry is the total fee or average fee for all the prescriptions, and/or those falling within certain categories. Additionally, the selling price, cost, and/or profit margin can be broken down into an average for all of the prescriptions, and/or those falling within a certain category. Further, a dollar volume amount and/or percentage can be determined for all prescriptions and/or those falling within a certain category. Also, a gross profit amount and/or percentage can be determined for all prescriptions and/or those falling within a certain category.

When identifying such areas, one is able to determine areas of problem for the particular pharmacy. For example, if the cost of a prescription is not correct, or if the cost of the prescription is over stated, then average cost is going to reveal such an error.

The entries discussed above are stated in the Analysis Report 14 in a reader friendly format, as shown for example in FIGS. 4A-4C. The Analysis Report 14 serves as a report card on the productivity of prescription sales, so as to provide, for example, a monthly and a year to date tracking. That is, the Analysis Report 14 reflects how the pharmacy is performing in different areas of interest, such as for example in pricing, reimbursement from third party payers, and brand name and generic prescription utilization. As such, the Analysis Report can be used to review the activities of the pharmacy and determine what areas, if any, need to be improved to enhance to operation of the pharmacy.

Preferably, the Analysis Report 14 can include a Summary 100, as shown in FIG. 4A; a Detail Report 104, as shown in FIG. 4B; and a Statistics Report 108, as shown in FIG. 4C.

In one embodiment of the Summary 100, a plurality of subcategories are introduced into the program 22. Examples of such plurality of subcategories are shown by way of illustration in FIG. 4A as: 1. “Cash”, 2. “Charge”, 3. “Champus”, 4. “Compounds”, 5. “Hospice”, 6. “IV's”, 7. “Major Medical”, 8. “Medicaid”, 9. “Medicare”, 10. “OTC”, 11. “3^{rd} Party”, 12. “Pharmacy Savers Club”, 13. “Vaccinations”, 14. “Wholesale/Employee”, and 15. “Worker's Comp”. As can be seen, each category produces a varied margin of profit and contains information which can be used to ensure that the pharmacy system has been set up correctly. As such, the Summary 100 facilitates the identification of activities in need of improvement.

For each of the subcategories, the Summary Report 100 lists a breakdown of the subcategory figures. This includes the previous year's monthly data on number of prescriptions filled as well as the current month's prescriptions filled for the particular segment of business. Further, for the current month, the percent of total number of prescriptions filled can be reported for each subcategory. Also reported is generic and brand name prescription utilization, and the average fee for the generic and brand name prescriptions associated with the particular segment of business. Total dollar volume is reported for each segment of business, as well as the percent of the total dollar volume. Further, a dollar profit and a gross profit for each segment of business is reported, as well as the total dollar profit and gross profit percentages. In addition to the current month figures, a year to date dollar volume amount, a year to date dollar profit amount, and a gross profit percentage can also be reported for each segment of business.

Preferably, the Summary 100 of Analysis Report 14 further reports the overall or total number of prescriptions filled, the number of prescriptions filled using generic prescriptions and name brand prescriptions, and the percent of generic prescriptions and name brand prescriptions filled based on the total number of prescriptions filled. Additionally, the overall inventory replacement cost and the inventory replacement cost for generic prescriptions and brand name prescriptions is reported. The average fee or profit is also reported for the overall prescriptions, as well as for the generic prescriptions and the brand name prescriptions.

Further, the Summary 100 includes an overall dollar volume amount, as well as a dollar volume amount and a percentage of total dollar volume for generic prescriptions and brand name prescriptions. A gross profit amount and a percentage is also reported on the overall, generic, and brand name prescriptions dispensed. Further, a year to date dollar volume for the overall, generic, and brand prescriptions are reported, as well as the year to date gross profit dollar amount and gross profit percentage.

In one preferred embodiment, the Summary 100 also includes a comment portion 112. The comment portion 112 is used to automatically communicate problems or failures found throughout the Analysis Report 14 and/or to congratulate for successes and a job well done. To determine what comments are included in the comment portion 112, triggering parameters or desired standards are defined in the program 22 so that the program 22 can make comparisons. Such parameters or standards can be defined by a predetermined value or formula in the program 22, or they can be definable by the user making the request to generate the Analysis Report 14.

For example, when a minimum standard for generic utilization is not met, or the inventory replacement cost increased from a previous reporting, then comments relating to these determinations, including the calculated increased inventory replacement cost, can be reported in the comment section 112 of the Summary 100, as best shown in FIG. 4A. As another example, standards and comments can be applied in regards to average fee, average cost, average selling price, and average gross profits. For example, if a standard for the average fee for generic prescriptions was defined as $3.00, and the program 22 determines and indicates that only $2.57 was made on the average generic prescriptions filled by the pharmacy, then the program 22 would automatically insert comments in the comment portion 112 so as to advise the pharmacist that changes need to be made in the pricing schedule. Further, prescription volumes and sales, gross profit dollar amounts and profit percentages can be compared to a previous year's figures, and commented on in the comment portion 112.

Also, the program 22 can provide the comment portion 112 so as to allow for manual notations within the comment portion 112 via the computer 18 and at least one input device 26, and/or via handwritten notes.

The Detail Report 104 of the Analysis Report 14 focuses on activities relating to third party entities or pay plan programs. Such activities can include for example pricing, reimbursements and margin of profit. For each entity encountered by the pharmacy, the Detail Report 104 states the generic and brand name prescription utilization percentages. Preferably, at least one comment section 120 will be provided for each entity, which is similar to the comment section 112 of the Summary 100 discussed above. The comment sections 120 are used for automatic commenting on areas of interest, such as prescription cost, generic and brand name prescription utilization, selling price, fee, profit amount, and margin of profit. Accordingly, standards relating to these areas are defined in the program 22 (either by predetermined values or formulas or by the user) so that the program 22 can make the corresponding comparisons. For example, a standard for generic utilization for the entity can defined and commented on generally and/or according to a particular segment of business, as shown in FIG. 4B. Pricing and reimbursement can also be commented on in the Detail Report 104.

At the end of the entities's listing, the Detail Report further includes a Third Party Recap portion 124 which gives figures and comments for the combined entities in a similar manner done for each of the entities. The Third Party Recap portion 124 provides a recap of all the third party entities combined together to give an overall picture of how the entities' business affected the pharmacy. Preferably, the total number of overall prescriptions, as well as the totals for new and refill status prescriptions and for generic and brand name prescriptions, are reported. Also, the total prescription cost, total prescription sales, total profit dollar, total margin of profit for the current month and year to date, average prescription prices for the current month and year to date, average cost, average fee and percent of profit are reported. Further, if the generic utilization for the combined entities is below a standard defined in the program 22, then the program 22 can determine and report the additional inventory replacement cost due to the low standard generic utilization.

Included in the Detail Report 104, preferably at the end of the Detail Report 104, is also a Grand Totals section 128. The Grand Totals section 128 includes final reporting figures and comments on the overall activity of the pharmacy. Preferably included in the Grand Totals section 128 are the grand totals for the overall prescriptions filled, as well as the totals for the brand name and generic prescriptions and for the new and refilled prescriptions. Further, total prescriptions sells, total prescription costs, total profit dollar and total margin of profit for the current month and year to date, current month and year to date reporting on average prescription price, average cost and average fee and percent of profit are also reported. Also, total generic prescription cost and profit, and total brand name prescription cost and profit are reported. For comments in a comment section 132 of the Grand Totals Section 128, certain figures, such as the overall margin of profit, can be measured against standards defined in the program. Further, if the generic utilization is below a standard defined in the program 22, then the program 22 can determine and report the additional inventory replacement cost due to the low standard generic utilization. In general, this amount represents the total lost profits to the pharmacy.

The Statics Report 108 of the Analysis Report 14 provides a summary for the compound prescriptions 204, the brand name prescriptions 206, the generic prescriptions 208, and the total prescriptions 210 in terms of the status of the prescription as a new prescription 211 or as a refill 212. Preferably, for each category, the total number 216, cost 218, price 220, average cost 222, average selling price, and profit margin percentage 230 is reported. Also provided is an overall summary 234 for all the categories combined. The overall summary 234 preferably lists the total number of prescriptions 240, cost 242, price 244, average cost 246, average price 248, the average profit percentage 254, the percent of the total that were refill prescriptions 258, and the average number of prescriptions sold per day 260.

After the program 22 has generated the Analysis Report 14, the Analysis Report 14 is output as a data file. Preferably, the Analysis Report 14 is also displayed in a format viewable by the user (and/or other entities), such as for example by displaying the Analysis Report 14 on the screen of the monitor 40. Further, the Analysis Report 14 can be saved as a data file on a storage medium, such as for example on the internal memory of the computer 18, a network or website host computer or database, or an external computer readable medium (e.g., a disk). Also, the Analysis Report 14 can be output to a printer 42 so that the Analysis Report 14 is printed out as a hard copy. Further, the Analysis Report 14 can be transmitted to the user (or another entity) via email.

From the above description, it is clear that the present invention is well adapted to carry out the objects mentioned herein as well as those inherent in the invention. While presently preferred embodiments of the invention have been described for purposes of this disclosure, it will be readily understood by those skilled in the art that changes may be made in the embodiments depicted and described herein, or in the elements, steps, and/or sequence of steps of the methods depicted and described herein without departing from the spirit and the scope of the invention as disclosed.

What is claimed is:

1. A method for providing an analysis report for reporting the servicing activities of a pharmacy filling a plurality of. prescriptions, the method comprising:
providing a computer having at least one input device and at least one output device;
providing a program for the computer;
inputting, via the at least one input device, for each prescription, servicing information, wherein the servicing information includes at least a filling date, a description of the prescription, a classification of the prescription, a status of the prescription, a cost price associated with the prescription, a selling price associated with the prescription, and an entity paying on the prescription;
electronically generating and outputting an analysis report utilizing at least a portion of the servicing information received, the analysis report having analysis information indicative of at least one of an average cost price for the plurality of prescriptions, an average cost for the prescriptions associated with each entity, a total cost for the plurality of prescriptions, an average selling price for the plurality of prescriptions, an average selling price for the prescriptions associated with each entity, a total sale for the plurality of prescriptions, an average profit margin for the plurality of prescriptions, an average profit margin for the prescriptions associated with each entity, a percentage of utilization for at least one classification of prescription, or a percentage of utilization for each entity for at least one classification of prescription.

2. The method of claim 1, wherein the analysis report is generated with reference to at least one time period.

3. The method of claim 2, wherein the at least one time period is a month.

4. The method of claim 2, wherein the at least one time period is a year to date period.

5. The method of claim 2, wherein the at least one time period is a month and a year to date period.

6. A pharmacy management analysis report for reporting the servicing activities of a pharmacy filling a plurality of prescriptions, the analysis report comprising:
analysis information indicative of at least one of an average cost price for the plurality of prescriptions, an average cost for the prescriptions associated with each entity, a total cost for the plurality of prescriptions, an average selling price for the plurality of prescriptions, an average selling price for the prescriptions associated with each entity, a total sale for the plurality of prescriptions, an average profit margin for the plurality of prescriptions, an average profit margin for the prescriptions associated with each entity, a percentage of utilization for at least one classification of prescription, or a percentage of utilization for each entity for at least one classification of prescription.

7. The analysis report of claim 6, wherein the analysis report relates to at least one time period.

8. The analysis report of claim 7, wherein the at least one time period is a month.

9. The analysis report of claim 7, wherein the at least one time period is a year to date period.

10. The analysis report of claim 7, wherein in the at least one time period is a month and a year to date period.

11. A system for generating a pharmacy management analysis report for reporting the servicing activities of a pharmacy, the system comprising:
a computer having at least one input device and at least one output device;
a program for instructing the computer to perform the following steps:
receive, for each prescription, servicing information, wherein the servicing information is indicative of a filling date, a description of the prescription, a classification of the prescription, a status of the prescription, a cost price associated with the prescription, a selling price associated with the prescription, and an entity paying on the prescription;
determine, utilizing at least a portion of the servicing information received, analysis information indicative of at least one of an average cost price for the plurality of prescriptions, an average cost for the prescriptions associated with each entity, a total cost for the plurality of prescriptions, an average selling price for the plurality of prescriptions, an average selling price for the prescriptions associated with each entity, a total sale for the plurality of prescriptions, an average profit margin for the plurality of prescriptions, an average profit margin for the prescriptions associated with each entity, a percentage of utilization for at least one classification of prescription, or a percentage of utilization for each entity for at least one classification of prescription; and
output the analysis information in a computer readable data file so as to provide the analysis report.

12. The system of claim 11 further comprising at least one input device connected to the computer, and wherein at least a portion of the servicing information is received via the computer and the at least one input device.

13. The system of claim 11 further comprising at least one output device connected to the computer, and wherein the analysis report is output to the at least one output device.

14. The system of claim 13, wherein the at least one output device is a monitor.

15. The system of claim 13, wherein the at least one output device is a printer.

16. The system of claim 11 further comprising a storage medium for saving the data file.

17. The system of claim 16, wherein the storage medium is at least one of an internal memory of the computer, a network computer, a network database, a website host computer, a website host database, or an external computer readable medium.

18. The system of claim 11, wherein the computer readable instructions are stored on at least one of an internal memory of the computer, a network computer, a network database, a website host computer, a website host database, or an external computer readable medium.
